(19) United States
(12) Patent Application Publication
(10) Pub. No.: US 2024/0193572 A1
(43) Pub. Date: Jun. 13, 2024

(54) Physical Point-of-Sale Integration With Third-Party Expense Systems

(71) Applicant: ZEBRA TECHNOLOGIES CORPORAITON, Lincolnshire, IL (US)

(72) Inventor: Zenon Nestor Evans, Chicago, IL (US)

(21) Appl. No.: 18/080,670

(22) Filed: Dec. 13, 2022

(51) Int. Cl. G06Q 20/20; G06Q 20/38; G06Q 20/40

(52) U.S. Cl. CPC G06Q 20/206; G06Q 20/208; G06Q 20/3821; G06Q 20/4014; G06Q 2220/00

(57) ABSTRACT

System and methods for a point-of-sale system integrated with third-party applications. The system includes a user interface and transceiver to interrogate tags. A plurality of applications having respective identifiers interface with application servers via APIs. A controller connected to the transceiver and user interface triggers the transceiver to interrogate tags to obtain a data string. The data string indicates an application identifier and user credential. The controller identifies an application based on the application identifier. The controller submits transaction information for a transaction performed via the POS system to a user account associated with the user credential. The controller formats the communication in accordance with the API of the application server corresponding to the identified application.

### BACKGROUND

Submitting business expenses for reimbursement generally involves multiple steps. For example, if expensing a dinner during a business trip, generally the person requiring reimbursement must pay the check, which may involve having to carry and pay with a company credit card and/or interact with a person such as a sales representative or wait staff; receive a receipt or proof of payment, which may be a paper receipt, photograph of a receipt, an electronic receipt or other proof of payment; submit the proof of payment/receipt to an expense reporting system; and classify the expenses to ensure proper processing. This can be time consuming, tedious and prone to mistake, error and/or failure at any one of the aforementioned steps of the process.

Moreover, when paying a bill and/or checking out at a point-of-sale, it would be convenient for a user to concurrently handle expense reporting for the transaction.

Accordingly, there is a need for an expense reporting system which improves upon, and alleviates, the aforementioned challenges.

### SUMMARY

In an embodiment, the present invention is a point-of-sale (POS) system which may also provide the ability for expense reporting.

In an embodiment, a point-of-sale (POS) system may include a user interface; a transceiver configured to interrogate one or more tags; a memory storing a plurality of applications having respective identifiers, the applications being configured to interface with one or more application servers via respective one or more application programming interfaces (APIs); a controller operatively connected to the transceiver and the user interface, wherein the controller may be configured to trigger the transceiver to interrogate the one or more tags to obtain a data string indicative of an application identifier and a user credential; identify an application based on the application identifier; obtain transaction information for a transaction performed by the user via the POS system; generate an instruction to submit the transaction information to an account associated with the user credential, wherein the instruction may be formatted in accordance with the one or more APIs of the one or more application servers corresponding to the identified application; and transmit the instruction to the one or more application servers.

In an aspect, the POS system user interface may be configured to receive a user identifier associated with a user and the instruction generated by the controller may include the user identifier.

In an aspect, the POS system controller may be configured to authenticate with one or more application servers using the user credential and generate an instruction responsive to the authentication. In an aspect of POS system, the user credential may include one or more of a user name, a password or a one-time password. In an aspect, the instruction indicates user classification data indicating one or more of an expense category, a reference identifier, or comment data for at least a portion of the transaction information. In an aspect, the POS system user interface may further include a display unit and responsive to the authentication, the controller may be configured to receive, from the one or more application servers, classification data for the account associated with the user credential and present, via the display unit, the classification data.

In an aspect of the POS system, the user credential may be a first user credential and to authenticate with the one or more application servers, the controller may be configured to authenticate with an one or more intermediate servers using the first user credential: obtain, from the one or more intermediate servers, a second user credential for authentication with the one or more application servers; and authenticate with the one or more application servers using the second user credential. In an aspect of the POS system, the one or more intermediate servers may use an open standard for authentication.

In an aspect, the POS system may be implemented at a personal electronic device and the user credential may include one or more of a user name, a password or a one-time password.

In an aspect of the POS system, the transceiver may include an RFID transceiver and the one or more tags may include one or more RFID tags embedded in a tap card.

In an embodiment, a point-of-sale (POS) system may include a user interface including a display unit; a memory storing a plurality of applications having respective identifiers, the applications being configured to interface with one or more application servers via respective one or more application programming interfaces (APIs); a controller operatively connected to the user interface, wherein the controller may be configured to identify an application based on the application identifier; obtain transaction information for a transaction performed by the user via the POS system; generate an instruction to submit the transaction information to an account associated a user credential, wherein the instruction may be formatted in accordance with the one or more APIs of the one or more application servers corresponding to the identified application; and transmit the instruction to the one or more application servers.

In an embodiment, a computer-implemented method for point-of-sale (POS) third-party application integration implemented at a point of sale system. The method may include (i) a user interface; (ii) a transceiver configured to interrogate one or more tags; (iii) a memory storing a plurality of applications having respective identifiers, the applications may be configured to interface with one or more application servers via respective one or more application programming interfaces (APIs); and (iii) a controller operatively connected to the transceiver and the user interface, wherein the method may include (1) triggering, via the controller, the transceiver to interrogate one or more tags to obtain a data string indicative of an application identifier and a user credential; (2) identifying, via the controller, an application based on the application identifier; (3) obtaining, via the controller, transaction information for a transaction performed by the user via the POS system; (4) generating, via the controller, an instruction to submit the transaction information to an account associated with the user credential, wherein the instruction may be formatted in accordance with the one or more APIs of the one or more application servers corresponding to the identified application; and (5) transmitting, via the controller, the instruction to the one or more application servers.

In an aspect, the computer-implemented method may further include, authenticating, via the controller, with the one or more application servers using the user credential and generating, via the controller, the instruction responsive to the authenticating.

In a further aspect of the computer implemented method, in response to the authentication, the method may include receiving, via the controller, classification data for the account associated with the user credential and presenting, via the controller, the classification data. In an aspect of the computer implemented method, the instruction indicates user classification data indicating one or more of an expense category, a reference identifier, or comment data for at least a portion of the transaction information.

In an aspect of the computer implemented, the user credential is a first user credential and authenticating with the one or more application servers may include authenticating, via the controller, with one or more intermediate servers using the first user credential; obtaining, via the controller, a second user credential for authentication with the one or more application servers; and authenticating, via the controller, with the one or more application servers using the second user credential.

In an aspect of the computer implemented method, the POS system may be implemented at a personal electronic device and the user credential may include one or more of a user name, a password or a one-time password.

In an aspect of the computer implemented method, the transceiver may include an RFID transceiver and the one or more tags may include one or more RFID tags embedded in a tap card.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a POS system integrated with third party application systems, in accordance with some embodiments.

FIG. 2 depicts exemplary interfaces associated with submitting transaction information to an expense reporting application via a POS system, in accordance with some embodiments.

FIG. 3 is a flowchart of a method for POS third-party application integration in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

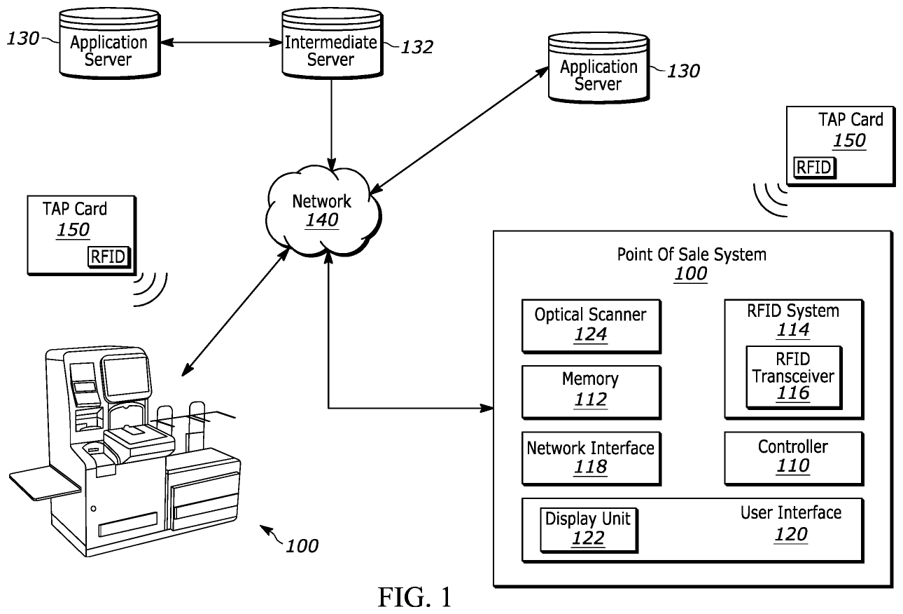

FIG. 1 is a block diagram representative of a point of sale (POS) system 100 and the various components thereof capable of implementing the techniques, systems and/or methods described herein. While FIG. 1 illustrates the POS system 100 as having a self-checkout form factor, in other embodiments, the POS system 100 has an employee-checkout form factor and/or a personal electronic device form factor (e.g., a smartphone, a tablet, a wearable, a laptop, a head-mounted display (e.g., for augmented reality, virtual reality and/or mixed reality), or any other electronic device suitable for facilitating the purchase of items). The POS system 100 functions as a logic platform capable of executing instructions to, for example, implement operations of the example methods described herein, as may be represented by the flowcharts of the drawings that accompany this description. Example logic platforms include, for example, implementing operations of the example system described herein via field programmable gate arrays (FPGAs) and application specific integrated circuits (ASICs).

The POS system 100 may include a controller 110, a memory 112, a radio frequency identification (RFID) system 114 having an RFID transceiver 116, a network interface, a user interface 120 having display unit 122 and an optical scanner 124. The POS system 100 may be in wireless and/or wired communication with an application server 130 and/or an intermediate server 132 via a network 140. In addition, the POS system 100 may be in wireless communication with a tap card 150 (e.g., an RFID tap card, a near field communication (NFC) card, a Bluetooth card, an ultrawide band (UWB) card, etc.). While the following description generally refers to RFID tap cards, any such reference envisions tap cards that implement alternate communication protocols and/or standards. The controller 110 may include one or more processors such as, for example, one or more microprocessors, controllers, and/or any suitable type of processor.

The memory 112 (e.g., volatile memory, non-volatile memory) may be accessible by the controller 110 (e.g., via a memory controller).

The example POS controller 110 may interact with the memory 112 to obtain, for example, machine-readable instructions stored in the memory 112 corresponding to, for example, one or more applications used to carry out the POS system 100 expense reporting techniques disclosed herein. Additionally, or alternatively, machine-readable instructions corresponding to the example operations described herein may be stored on one or more removable media (e.g., a compact disc, a digital versatile disc, removable flash memory, etc.) which may be coupled to the POS system 100 to provide access to the machine-readable instructions stored thereon.

The controller 110 may be operably connected to any and/or all components of the POS system 100, such as the RFID system 114, the RFID transceiver 116, and/or user interface 120, to name but a few, as well as any other components, parts, devices and the like which may be suitable for control by a controller.

The network interface 118 enables communication with other machines (e.g., one or more applications servers 120 or authentication servers) via, for example, one or more networks 140. The example network interface 118 includes any suitable type of communication interface(s) (e.g., wired and/or wireless interfaces) configured to operate in accordance with any suitable protocol(s). In one aspect, wireless communication may include IEEE 802.11, Wi-Fi, Bluetooth, RF, cellular (e.g., CDMA, LTE, EV-DO, 5G, 4G, 3G), WLAN, infrared, or any other suitable wireless communication means. In another aspect, the communication may be wired, such as Ethernet.

The user interface 120 may provide input and/or output to the POS system 100, such as user input. For example, the user interface 120 may include a display unit 122 (e.g., LCD, LED, OLED an/or touchscreen); one or more audio output units such as a speaker; one or more input units (e.g., physical keyboard and/or keypad, soft/touchscreen keyboard and/or keypad, stylus, and/or mouse); and/or a payment processing unit (e.g., a credit card processing system and/or an automated money acceptance unit), as well as any other suitable user interface components. In embodiments where the POS system 100 has an employee-checkout form factor, the POS system 100 may include the display unit 122 to support customer interactions and an additional display unit (not depicted) to support employee interactions.

The optical scanner 124 is configured to scan a barcode corresponding to an object, such as an item to be purchased at the POS system 100. The optical scanner 124 may include one or more image sensors, image processors, light emitting diodes, and/or other imaging components configured to sense the barcode and decode a product identifier encoded by the barcode. The optical scanner may include at least one bioptic scanner built into a housing of the POS system 100 and a handheld scanning unit.

The RFID system 114 is configured to sense, interrogate, read from and/or write to one or more RFID tags affixed to objects, such as a tap card 150, which may include reading and/or writing data strings to a memory of the RFID tags. The tap card 150 may be a physical card containing RFID circuitry and/or functionality, such that the tap card 150 provides one or more RFID tags.

In some embodiments, the RFID system 114 includes one or more RFID transceivers 116 via which the RFID system 114 exchanges radio frequency (RF) signals with the RFID tags. To execute a read or write operation, the RFID system 114 may generate and transmit, via the RFID transceiver 116, an instruction formatted in accordance with an RFID protocol, such as ISO 18000. Responsive to transmitting a read instruction (also referred to as interrogating the RFID tag), the RFID transceiver 116 receives a message and/or data from the RFID tags which may include an indication of a requested parameter (e.g., a user identifier, an application identifier). Responsive to transmitting a write instruction, the RFID transceiver 116 receives a message and/or data identifying whether or not the RFID tag performed the write operation successfully. In some embodiments, the transceiver 116 operates solely as an RFID reader or solely as an RFID writer, and does not include the components for performing read and write operations.

While FIG. 1 depicts the POS system 100 as only including the RFID system 114, in other embodiments the POS system 100 may include similar components (e.g., transceivers) for communicating with tap cards 150 that implement other communication protocols and/or standards.

As shown in an embodiment according to FIG. 1, the POS system 100 may be integrated with a third party application system. As mentioned above, the POS system 100 may include a user interface 120, an RFID transceiver 116 configured to interrogate one or more RFID tags, a memory 112 storing a plurality of applications having respective application identifiers, and a controller 110 operatively connected to the RFID transceiver 116 and user interface 120.

In an aspect, the POS system 100 may store one or more applications, such as an expense reporting application, in the memory 112. It should be appreciated that while the instant disclosure generally refers to expense reporting applications, the disclosed authentication and/or authorization techniques may be applied to other types of third-party applications stored in the memory 112. In one aspect, the applications may include a local component that resides in the POS system 100 locally, e.g., in the POS memory 112. In another aspect, the applications include an external component and may be located outside of the POS system 100, e.g., in the cloud and/or hosted by a third-party service such as Amazon Web Services (AWS). Accordingly, the POS system 100 may be in communication with one or more application servers 130 respectively corresponding to the one or more applications stored in the memory 112 of the POS system 100. For example, the POS system 100 can interface with an application executed at a corresponding application server 130 via one or more of an application programming interface (API), a plugin, a widget, a microservice, or other type of suitable software module.

The POS system 100 may communicate with one or more application servers 130 over a network 140 via the network interface 118. The network 140 may include any suitable type of communication network(s) (e.g., wired and/or wireless networks) configured to support communications formatted in accordance with any suitable protocol(s). In one aspect, wireless network 140 may support include IEEE 802.11, Wi-Fi, Bluetooth, RF, cellular (e.g., CDMA, LTE, EV-DO, 5G, 4G, 3G), WLAN, infrared, or any other suitable wireless communication means. In another aspect, the network 140 may support wired communications, such as Ethernet. The POS system 100 may communicate unidirectionally and/or bidirectionally with one or more application servers 130. The POS system 100 may communicate directly with one or more application servers 130, or indirectly, e.g., through one or more intermediate servers 132 as discussed in more detail herein. In an aspect, the public component of an application stored in the memory 112 may provide a network location at which the POS system 100 may interface with the application servers 130.

According to an embodiment, a user conducts a checkout via the POS system 100. Accordingly, the memory 112 may include a checkout application that is executed by the controller 110 to guide the user through the checkout process. At any point during the checkout process, the controller 110 may configure the user interface 120 to present an option in which the user is prompted to submit transaction information to a third-party expense reporting application. In response to detecting a user input to initiate the submission process, the checkout application may cause the POS system 100 to initiate an authentication process to obtain a user credential for an expense reporting application.

In some embodiments, the user credential may be obtained via RFID. In these embodiments, the controller 110 may be configured to trigger the RFID transceiver 114 to interrogate one or more RFID tags to obtain a data string from an RFID tag embedded in the RFID tap card 150. In an aspect, the data string may include an application identifier that identifies one of the applications stored in the memory 112 and/or a user credential for authenticating the user with the application.

In an aspect, the user may provide an input to initiate the submission process by bringing the tap card 150 within range of the RFID transceiver 116 without being prompted via the user interface 120. In these embodiments, the controller 110 may configure the RFID system 114 to operate in a standby mode via which the RFID system 114 detects the presence of nearby RFID tags, such as the RFID tag embedded in the tap card 150. In response to detecting the presence of the RFID tag, the RFID system 114 may interrogate, read, receive or otherwise obtain the data string from the one or more RFID tags of the tap card 150. In an aspect, the user may be prompted via the user interface 120 to bring the tap card 150 within range of the RFID transceiver 116.

After obtaining the data string, the POS system 100 may extract the application identifier from the data string and analyze the application identifier to identify an application stored at the memory 112. For example, a first identifier may correspond to Expensify, a second identifier may correspond to Smart Receipts, a third identifier may correspond to ZOHO Expense, and so on. It should be appreciated in some embodiments, the data string received from the RFID tag of the tap card 150 may not include an application identifier. In these embodiments, in response to detecting a read event, the controller 110 may configure the user interface 120 to present a selection interface via which the user is able to manually select an application stored in the memory 112.

After identifying the application that corresponds to the application identifier, the controller 110 may initiate an authentication process with the application. For example, the authentication process may utilize a standard authentication protocol, such as Open Authorization (“OAuth”) and/or Security Assertion Markup Language (SAML) protocols that enable users to log into their accounts via publicly-accessible devices (such as the POS system 100) without providing a username/password. For example, in an OAuth process, the POS system 100 may transmit the user credential to an OAuth server and the OAuth server may respond with an access token to utilize when communicating with the application server 130. When the application server 130 receives the access token, the application server 130 can associate the access token with the user account for the user maintained at the application server 130 and authorize the POS system 100 to perform a set of actions related to, for example, adding items purchased via the POS system 100 to an expense report. In this sense, standard authentication protocols grant the POS system 100 only enough permissions to allow the POS system 100 to, for example, send a request to an expense reporting application without exposing any private data to the POS system 100. In some embodiments, the software instructions that implement the standard authentication protocol(s) are included in the local component of the application stored in the memory 112.

While it is preferable to use a standard authentication protocol to ensure data privacy at the POS system 100, users may forget to bring the RFID tap card 150 to the venue. Accordingly, the POS system 100 may be configured to support username and password based authentication techniques as an alternate authentication method. Additionally or alternatively, a one-time password (OTP) authentication may implemented as the fallback authentication technique.

In another aspect, the authentication techniques implemented at the POS system 100 may be applied to authenticate the user with one or more non-expense reporting applications the user would like to use. For example, the memory 112 may store a corporate application that authenticates users to provide secure access to various applications within the user's corporate environment (e.g., Okta, Duo, etc.). In such an aspect, the RFID tag of the tap card 150 may store a data string that identifies the corporate application stored at the POS system 100 software and/or memory 112.

In this example, the POS system 100 may authenticate with an application server 130 that hosts the corporate application as an intermediate application server 132. In response to receiving the authentication request from the POS system 100, the intermediate server 132 may provide an access token for the POS system 100 to use when interfacing with the application server 130. Said another way, the POS system 100 may interface with middleware applications, services and/or servers that provide direct and/or indirect communication or other interaction between the POS system 100 (e.g., which may be a front-end in this example) and one or more application servers 130, applications, and/or services, (e.g., which may be a back-end in this example). Any other suitable means may be used to provide direct and/or indirect communication or other interaction between the POS system 100 and one or more application servers 130, applications and/or services.

During the checkout process, the controller 110 obtains transaction information for a transaction performed by the user via the POS system 100. For example, the transaction information may include a product identifier, a product cost, a product quantity, etc. for any items being purchased during the checkout process. The controller 110 may generate an instruction to submit the transaction information to an account associated with the user credential associated with the application identifier. In an aspect, the checkout application may invoke the local component of the expense reporting application (e.g., the API) using the transaction information as an input. In response, the controller 110 may execute instructions defined by the API to packetize the transaction information in accordance with a protocol defined by the API and transmit the instruction to the one or more application servers 130.

Once the application (e.g., an expense reporting application) the user would like to use is known by the POS system 100 based at least on the application identifier, authentication information associated with the user's account for the expense reporting application must be provided to the POS system 100. The tap card 150 may provide user account authentication information in the user credential data provided by the tap card's 150 RFID data string to the POS system 100. In another aspect the user credential may be entered as an input via the user interface 120.

In an aspect, once the POS system 100 has access to the user's account in the expense reporting application, the POS system 100 may generate an instruction to submit the user's transaction information to the application and/or account associated with the user's credentials. In an aspect, the instruction may be formatted in accordance with the one or more APIs of the one or more application servers 130 corresponding to the expense reporting application identified by the POS system 100. The POS system 100 may have one or more instructions, stored, accessed and/or transmitted locally or remotely to the POS system 100, related to the formatting for each of the one or more expense reporting applications.

In a further aspect responsive to the authentication, the controller 110 may be configured to receive, from the one or more application servers 130, classification data for the account associated with the user credential. For example, the classification data may include classification options (e.g., expense type, reference numbers, comment fields, etc.) for classifying transaction items associated with the checkout process facilitated by the POS system 100. In response, the controller 110 may configure the user interface 120 to present a user interface configured to enable the user to classify the transaction information in accordance with the classification data. In an aspect, the user interface 120 may detect the user classification data. In another aspect the user interface 120 is configured to detect user input to classify the transaction information, additionally or alternatively, any other suitable method may be used by the user to classify the transaction information. In another aspect, the controller 110 may classify the transaction information in accordance with the classification data via one or more of machine learning, artificial intelligence, and a neural network.

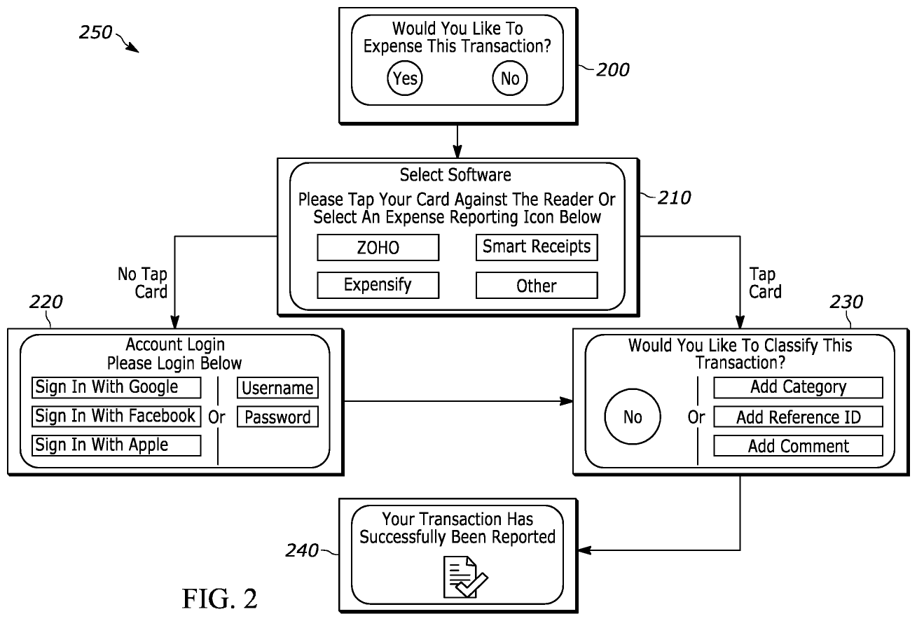

FIG. 2 depicts a series 250 of exemplary graphical user interfaces (GUIs) 200-240 associated with submitting transaction information to an expense reporting application via a POS system 100, in accordance with some embodiments. The POS system 100 may be configured via controller 110 to display the GUIs and receive inputs via the one or more user interfaces 120, e.g., via the display unit 122. It should be appreciated that the depicted GUIs are merely examples, and that alternative or additional GUIs are envisioned.

In an aspect, the series 250 begins when the POS controller 110 provides an instruction to the user interface 120 to display the GUI 200 on the display unit 122. In an aspect, instructions for presenting the GUI 200, as well as the other GUIs discussed herein, may be stored locally, e.g., in the memory 112 and accessible by the controller 110. The illustrative GUI 200 may be provided at any point before, during and/or after a transaction at the POS system 100 occurs. The GUI 200 may provide an option to expense the transaction. The GUI shown provides “Yes” or “No” responses regarding whether to expense the transaction via the POS system 100, although it is contemplated that this GUI 200, as well as the other GUIs discussed herein, may present additional and/or other options which would result in the same, similar and/or any other suitable functionality. In an aspect, responsive to detecting an election to expense a transaction, the controller 110 configures the RFID system 114 to operate in an active state, to allow an RFID tag to subsequently be read by the RFID system 114.

In an aspect, the sequence 250 may continue when the controller 110 instructs the user interface 120 to display the GUI 210 in response to detecting an election to expense a transaction (e.g., via the “Yes” button of the GUI 200). The GUI 210 may present a menu of expense reporting software applications for user selection. In an aspect, the icons displayed via touchscreen display unit 122 may be associated with respective expense reporting software stored in the memory 112. Accordingly, the controller 110 may obtain an application identifier based on which icon is selected by the user. In an aspect, the user may alternatively and/or additionally bring a tap card 150 within range of the RFID transceiver 116. As described elsewhere herein, the tap card 150 may be configured to transmit a data string to the RFID system 114 that includes an indication of the application identifier.

In an aspect, once the software selection is made, the POS system 100 may execute the selected expense reporting software from memory 112, from an application server 130 (e.g., accessed via network 140), and/or any combination thereof.

In an aspect, if the user selected an icon from the GUI 210 (e.g., the user did not use the tap card 150), the sequence 250 may proceed by the controller 110 instructing the user interface 120 to display GUI 220. GUI 220 may request user credentials to login and/or authenticate an account associated with the previously-elected software. As discussed supra, the user credential may include a user name and/or password for an account; an OTP and/or any other user suitable credential to authenticate an account. Providing authentication may involve communication and/or interaction by the POS system 100 and/or controller 110 with one or more of an application server 130 and/or an intermediate server 132 via a network 140.

In an aspect, if the controller 110 detects a data string received via the RFID transceiver 116 from the tap card 150, the controller 110 may analyze the data string to obtain an application identifier and/or user credential. As described elsewhere herein, the controller 110 may then initiate an authentication process using the user credential with the application server 130 corresponding to the application identifier. For example, the authentication process may implement a standard authentication protocol, e.g., OAuth or SAML. In response, the controller 110 may obtain an access token to use for subsequent interactions with the application server 130 relating to the transaction. As such, the controller 110 may skip presenting the GUI 220 in response to detecting a data string provided by the tap card 150.

In an aspect, after being authenticated with the application server 130, the sequence 250 may continue when the controller 110 instructs the user interface 120 to present the GUI 230. The GUI 230 may be configured to enable the user to classify the transaction and/or the individual transaction items thereof. In an aspect, the application server 130 may be configured to provide the classification options to the POS system 100 in response to authenticating the POS system 100. As illustrated, the classification options may include one or more of an expense category, a reference identifier, and/or comment data. For example, the application server 130 and/or the user account thereat may permit categorizing the transaction as dining, transportation, office supplies, and/or any other suitable category for a transaction. In an aspect, a reference identifier may be an internal company reference number associated with a client for which an expense was associated. In an aspect, a comment field may be provided to be associated with the transaction. In an aspect, the controller 110 may update transaction information data to include the classification information in response to detecting classification inputs provided by the user via the GUI 230.

In one embodiment and as discussed supra, a user may initiate the expense submission process by bringing the tap card 150 within range of the RFID transceiver 116 without being prompted via the user interface 120. In these embodiments, the controller 110 may configure the RFID transceiver 116 to operate in a standby mode via which the RFID system 114 detects the presence of nearby RFID tags, such an RFID tag embedded in the tap card 150. In response to detecting the presence of the RFID tag, the RFID system 114 may interrogate, read, receive or otherwise obtain the data string from the one or more RFID tags of the tap card 150. In these embodiments, the information requested by GUIs 200 (e.g., whether to expense a transaction), 210 (e.g., selection of expense reporting software), and/or 220 (e.g., user credentials) may be obtained by the controller 110 automatically and without detecting user interactions with the display unit 122. As such and in these embodiments, the controller 110 may initiate the sequence 250 by instructing the user interface 120 to display the GUI 230.

In an aspect, after detecting that the user has finished classifying the transaction, the controller 110 may subsequently generate an instruction to submit the transaction information to the application server 130. The instruction may include an indication of the user account and/or an access token received from the application server 130. As described elsewhere herein the instruction may be formatted in accordance with the one or more APIs of the one or more application servers 130. After transmitting the instruction to submit the transaction information, the controller 110 may receive an acknowledgement from the application server 130 that the transaction information was successfully submitted.

In response to receiving the acknowledgement, the sequence 250 may continue when the controller 110 instructs the user interface 120 to present the GUI 240. As illustrated, the GUI 240 is configured to indicate to the user that the transaction has been successfully reported.

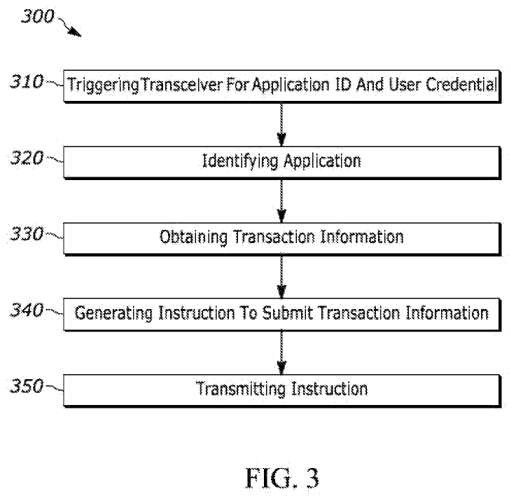

FIG. 3 is a flowchart of a computer-implemented method 300 for point-of-sale (POS) third-party application integration, in accordance with some embodiments.

In an embodiment, the computer-implemented method 300 for point-of-sale (POS) third-party application integration may be implemented at a point of sale system 100 which may include (i) a user interface (e.g., the user interface 120); (ii) a transceiver configured to interrogate one or more tags; (iii) a memory (e.g., the memory 112) storing a plurality of applications having respective identifiers, the applications being configured to interface with one or more application servers (e.g., the application servers 130) via respective one or more application programming interfaces (APIs); and (iv) a controller (e.g., the controller 110) operatively connected to the transceiver and the user interface 120.

The computer-implemented method 300 may include (1) at block 310 triggering, via the controller 110, a transceiver to interrogate one or more tags to obtain a data indicative of an application identifier and a user credential; (2) at block 320 identifying, via the controller 110, an application based on the application identifier; (3) at block 330 obtaining, via the controller 110, transaction information for a transaction performed by the user via the POS system 100; (4) at block 340 generating, via the controller 110, an instruction to submit the transaction information to an account associated with the user credential, wherein the instruction is formatted in accordance with the one or more APIs of the one or more application servers 130 corresponding to the identified application; and (5) at step 350 transmitting, via the controller 110, the instruction to the one or more application servers 130.

In an aspect, the computer-implemented method 300 may further include authenticating, via the controller 110, with the one or more application servers 130 using the user credential and generating, via the controller 110, the instruction responsive to the authenticating. In an aspect of the computer implemented method 300, in response to the authentication, the method 300 may further include receiving, via the controller 110, classification data for the account associated with the user credential and presenting, via the display unit 122, the classification data. In a further aspect of the computer implemented method 300, the instruction may indicate user classification data indicating one or more of an expense category, a reference identifier, or comment data for at least a portion of the transaction information.

In an aspect of the computer implemented method 300, the user credential may be a first user credential and authenticating with the one or more application servers 130 may include authenticating, via the controller 110, with one or more intermediate servers 132 using the first user credential; obtaining, via the controller 110, a second user credential for authentication with the one or more application servers 130; and authenticating, via the controller 110, with the one or more application servers 130 using the second user credential.

In an aspect of the computer implemented method 300, the POS system 100 may be implemented at a personal electronic device and the user credential may include one or more of a user name, a password or a one-time password. In an aspect of the computer implemented method 300, the transceiver includes an RFID transceiver 116 and the one or more tags include one or more RFID tags embedded in a tap card 150.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising.” “has”, “having.” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

What is claimed:

1. A point-of-sale (POS) system comprising:
a user interface;
a transceiver configured to interrogate one or more tags:
a memory storing a plurality of applications having respective identifiers, the applications being configured to interface with one or more application servers via respective one or more application programming interfaces (APIs);
a controller operatively connected to the user interface and the transceiver and configured to:
trigger the transceiver to interrogate the one or more tags to obtain a data string indicative of an application identifier and a user credential;
identify an application based on the application identifier;
obtain transaction information for a transaction performed by the user via the POS system;
generate an instruction to submit the transaction information to an account associated with the user credential, the instruction being formatted in accordance with the one or more APIs of the one or more application servers corresponding to the identified application; and
transmit the instruction to the one or more application servers.

2. The POS system of claim 1, wherein:
the user interface is configured to receive a user identifier associated with a user; and
the instruction includes the user identifier.

3. The POS system of claim 1, wherein the controller is configured to:
authenticate with the one or more application servers using the user credential; and
generate the instruction responsive to the authentication.

4. The POS system of claim 3, wherein:
the user interface includes a display unit; and
responsive to the authentication, the controller is configured to:
receive, from the one or more application servers, classification data for the account associated with the user credential; and
present, via the display unit, the classification data.

5. The POS system of claim 4, wherein the controller configured to:
classify the transaction information in accordance with the classification data via one or more of machine learning, artificial intelligence, and a neural network.

6. The POS system of claim 4, wherein:
the instruction indicates user classification data indicating one or more of an expense category, a reference identifier, or comment data for at least a portion of the transaction information.

7. The POS system of claim 3, wherein:
the user credential is a first user credential; and
to authenticate with the one or more application servers, the controller is configured to:
authenticate with one or more intermediate servers using the first user credential;
obtain, from the one or more intermediate servers, a second user credential for authentication with the one or more application servers; and
authenticate with the one or more application servers using the second user credential.

8. The POS system of claim 7, wherein:
the one or more intermediate servers use an open standard for authentication.

9. The POS system of claim 1, wherein:
the POS system is implemented at a personal electronic device; and
the user credential includes one or more of a user name, a password or a one-time password.

10. The POS system of claim 1, wherein:
the transceiver is an RFID transceiver; and
the one or more tags are one or more RFID tags embedded in a tap card.

11. A computer-implemented method for point-of-sale (POS) third-party application integration implemented at a point of sale system that includes (i) a user interface; (ii) a transceiver configured to interrogate one or more tags: (iii) a memory storing a plurality of applications having respective identifiers, the applications being configured to interface with one or more application servers via respective one or more application programming interfaces (APIs); and (iv) a controller operatively connected to the user interface and the transceiver, wherein the method comprises:
triggering, via the controller, the transceiver to interrogate the one or more tags to obtain a data string indicative of an application identifier and a user credential;
identifying, via the controller, an application based on the application identifier:
obtaining, via the controller, transaction information for a transaction performed by the user via the POS system:
generating, via the controller, an instruction to submit the transaction information to an account associated with the user credential, wherein the instruction is formatted in accordance with the one or more APIs of the one or more application servers corresponding to the identified application; and
transmitting, via the controller, the instruction to the one or more application servers.

12. The computer-implemented method of claim 11, further comprising:
authenticating, via the controller, with the one or more application servers using the user credential; and
generating, via the controller, the instruction responsive to the authenticating.

13. The computer implemented method of claim 12, wherein the user interface includes a display unit and in response to the authentication, the method further comprises:
receiving, via the controller, classification data for the account associated with the user credential; and
presenting, via the display unit, the classification data.

14. The computer implemented method of claim 13, wherein:
the instruction indicates user classification data indicating one or more of an expense category, a reference identifier, or comment data for at least a portion of the transaction information.

15. The computer implemented method of claim 11, wherein:
the user credential is a first user credential; and
authenticating with the one or more application servers comprises:
authenticating, via the controller, with one or more intermediate servers using the first user credential;
obtaining, via the controller, a second user credential for authentication with the one or more application servers; and
authenticating, via the controller, with the one or more application servers using the second user credential.

16. The computer implemented method of claim 11, wherein:
the POS system is implemented at a personal electronic device; and
the user credential includes one or more of a user name, a password or a one-time password.

17. The computer implemented method of claim 11, wherein:
the transceiver includes an RFID transceiver; and
the one or more tags include one or more RFID tags embedded in a tap card.

18. A point-of-sale (POS) system comprising:
a user interface including a display unit;
a memory storing a plurality of applications having respective identifiers, the applications being configured to interface with one or more application servers via respective one or more application programming interfaces (APIs);
a controller operatively connected to the user interface, wherein the controller is configured to:
identify an application based on the application identifier;
obtain transaction information for a transaction performed by the user via the POS system;
generate an instruction to submit the transaction information to an account associated a user credential, the instruction being formatted in accordance with the one or more APIs of the one or more application servers corresponding to the identified application; and
transmit the instruction to the one or more application servers.
